(19) United States
(12) Patent Application Publication
(10) Pub. No.: US 2026/0102927 A1
(43) Pub. Date: Apr. 16, 2026

(54) UNIVERSAL SHOWERHEAD MOUNT FOR ROBOTIC MANIPULATION DURING AUTOMATED PROCESSING APPARATUS AND METHODS THEREOF

(71) Applicant: NxEdge, Inc., Boise, ID (US)

(72) Inventor: Dawson Knight, Boise, ID (US)

(21) Appl. No.: 19/358,102

(22) Filed: Oct. 14, 2025

Related U.S. Application Data
(60) Provisional application No. 63/707,661, filed on Oct. 15, 2024.

(51) Int. Cl. B25J 15/00; B25J 9/00; B25J 9/16

(52) U.S. Cl. CPC B25J 15/0019; B25J 9/0009; B25J 9/161

(57) ABSTRACT

A universal mount for a showerhead to be manipulated by a robotic arm is provided.

### CROSS-REFERENCE TO RELATED PATENT APPLICATIONS

The present application claims priority to United States Provisional Patent Application Serial Number 63/707,661 filed October 15, 2024, titled the same, which provisional application is incorporated herein by reference as if set out in full for all purposes.

### BACKGROUND

The technology of the present application relates to components for use in semiconductor manufacturing and, more particularly, to apparatuses and methods related to showerhead fabrication.

A semiconductor showerhead (“showerhead”) provides several critical functions in the semiconductor manufacturing process. The showerhead facilitates the distribution and delivery of process gases evenly during deposition processes. The showerhead typically provides a number of holes in a plate. The holes, including the size, shape, and distribution, arranged in the plate provide for the distribution of the process gases. As such, the holes designs are subject to tolerances that are difficult to meet.

Moreover, the showerhead effects one or more features when depositing material on a workpiece, such as by a plasma spray process. The showerhead and holes thereon provide for a more uniform distribution of the process gases over the workpiece. The showerhead also impacts the reaction between the process gases and the workpiece. These are but two exemplary impacts the showerhead has on the workpiece processing during a manufacturing process.

As can be appreciated, the showerhead must be precisely manufactured and machined within the required tolerances. Today’s processes require manipulation of the workpiece by people and machinists that impacts the yield of the showerhead manufacturing. The manipulation required is in part due to the variations and proprietary designs of showerheads from different original equipment manufacturers.

Thus, against this background, it would be desirable to provide apparatuses and methods to facilitate the automatic manipulation of different showerheads as they are processed and/or refurbished.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a mount is provided to allow a robotic arm to automatically manipulate a showerhead during a showerhead fabrication or processing system. The mount includes a sub pallet comprising an outer portion extending radially inwardly from an outer edge of the sub pallet and a plurality of anchor bores in the outer portion of the sub pallet, the sub pallet has an outer diameter; a plurality of threaded clamp parts residing in the plurality of anchor bores, the plurality of threaded clamp parts comprising at least a first set of threaded clamp parts; a pallet, the pallet having a pallet outer diameter less than the sub pallet outer diameter, the pallet comprising a pallet sidewall, a plurality of protrusions that extend radially outwardly from the pallet sidewall, and a plurality of axially extending sleeves extending from the plurality of protrusions, the plurality of axially extending sleeves having a bottom releasably coupled to the first set of threaded clamp part, the plurality of axially extending sleeves having a top opposite the bottom; a plurality of radially inwardly extending holders coupled to the top of the plurality of axially extending sleeves; a plurality of hooks wherein each hook comprises a radially outward portion coupled to a corresponding one of the plurality of radially inwardly extending holders and a radially inward portion comprising a lip that is configured to engage and hold an edge portion about at least one showerhead of the plurality of showerheads; and a robot interface coupled to at least one of the sub pallet or pallet configured such that a robotic arm can manipulate the mount.

In some embodiments, the mount comprises a plurality of pallets releasably coupled to the sub pallet.

These and other aspects of the present system and method will be apparent after consideration of the Detailed Description and Figures herein.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a partially exploded perspective view of a universal showerhead mount for robotic manipulation during automated processing consistent with the technology of the present technology.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to a universal mount for a showerhead that allows for robotic manipulation during automated processing. However, the technology described herein may be used with applications other than those specifically described herein. For example, the universal mount for a showerhead may be used for mounting other precision machined parts for process chambers where the orientation of the precision machined part is needed as the part moves from station to station as it is machined. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Showerheads today come in a variety of shapes, sizes, and configurations. After use, the lifetime of any particular showerhead may be extended by re-fabrication steps to bring aspects of the showerhead back to the original equipment manufacturing tolerances and the like. The re-fabrication requires machines that process the showerheads by knowing the exact location of the part from machine to machine, which currently is difficult and time consuming. Thus, the technology herein provides a universal mount to hold a showerhead with a robotic arm to allow for precise knowledge of the location of the showerhead during the processing steps. It is expected that this should significantly increase the yield and reduce the amount of additional processing. Also, if additional processing is required, the showerhead may be re-inserted into the machines using the robotic arm with knowledge of the part location.

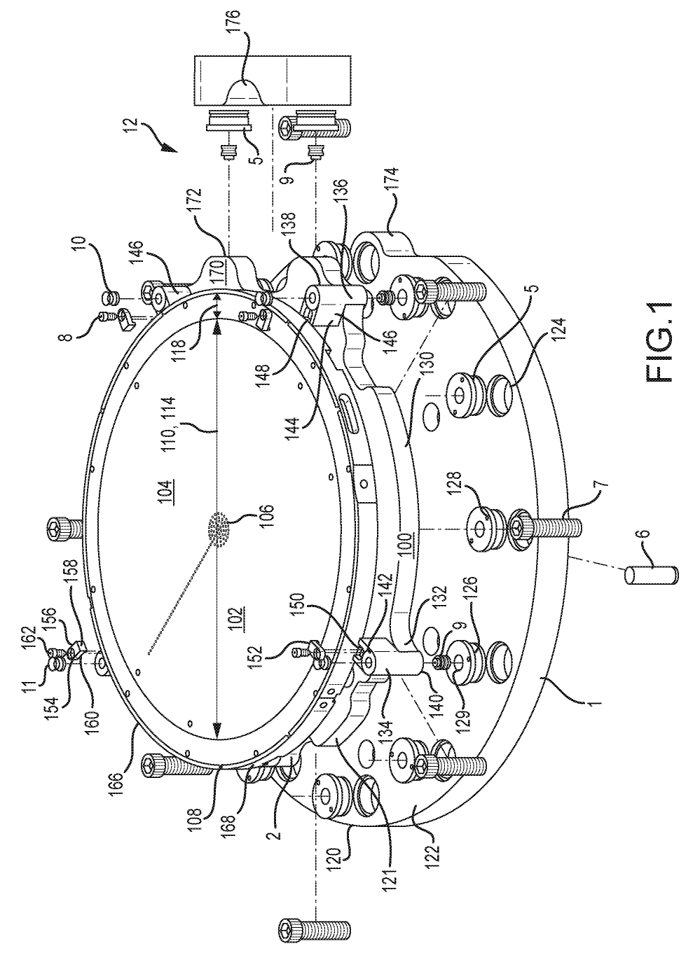

FIG. 1 shows a universal mount 100 for a showerhead 102. The showerhead 102 is shown is cylindrical in shape with a central working portion 104 having a plurality of distribution holes 106 machined into the central working portion 104. The holes are of a precise size, shape, and distribution in accordance with an original equipment manufacturing specification. While shown with a common cylindrical shape, other shapes are possible. A perimeter non-working portion 108 of the showerhead 102 surrounds the central working portion 104. The non-working portion 108 is shown without distribution holes 106, but one or more distribution holes 106 may be formed in the non-working portion 108 in certain embodiments. Also, the non-working portion 108 is shown to be contiguous around the central working portion 104, but the non-working portion 108 may be non-contiguous in certain embodiments. If non-contiguous, the non-working portion 108 may be arranged symmetrically or asymmetrically.

The central working portion 104 has a working portion outer diameter 110. The plurality of distribution holes 106 may be formed from the geometric center 112 of the central working portion 104 to the working portion outer diameter 110 or, in certain embodiments, the plurality of distribution holes 106 may only be located over a portion of the geometric center 112 to a radius short of the working portion outer diameter 110. The non-working portion 108 has a width 118. The non-working portion 108 has a non-working inner diameter 114 equal to the working portion outer diameter 110 and a non-working outer diameter 116 equal to the non-working inner diameter 114 plus the width 118, which is substantially equal to the showerhead outer diameter, although the showerhead 102 may, in certain embodiments, have additional portions extending beyond the non-working portion 108.

The universal mount 100 includes, in no particular order, a sub pallet 1, also a base 1 or base mount 1, and a pallet 2, or showerhead mount 2, removably coupled to the sub pallet 1. As shown in this exemplary embodiment, the pallet 2 is configured to couple to a showerhead 102, which is removably coupled to the pallet 2. The pallet 2 is removable from the sub pallet 1 to accommodate a plurality of pallets 2, of which only one is shown, as the universal mount 100 is configured to receive a plurality of different showerheads 102, of which only a single showerhead 102 is shown for convenience. The sub pallet 1 is configured to receive the plurality of pallets 2 as will be explained further below. As one of ordinary skill in the art will now understand on reading the disclosure, a plurality of pallets 2 accommodates a plurality of showerheads 102. In other words, the pallets 2 are configured to accommodate the different showerheads that have different central working portions, different non-working portions, and different diameters. Notice, a single pallet 2 may be useable with multiple showerheads 102, but often a single pallet 2 is configured to be usable with a single showerhead 102. Thus, while the sub pallet 1 remains constant for the universal mount 100, the unique aspects of the universal mount 100 allow for multiple combinations of the pallet 2 and showerhead 102.

The sub pallet 1 has a sub pallet outer diameter 120 that is larger than a pallet 2 outer diameter 121. The sub pallet 1 has an outer portion 122 extending radially inward from an outer edge of the sub pallet 1. Generally, the outer portion 122 extends radially inward and, in some embodiments, forms a bore that has a diameter at least about equal to the working portion of the showerhead. The bore in the sub pallet 1 allows machines to access both sides of the showerhead and an associated robotic arm to move the showerhead from machine to machine. In certain instances, the machine may have a cover plate that covers the bore as access to the showerhead from one or the other side is not needed by that machine. A plurality of anchor bores 124 are arranged about an outer portion 122 of the sub pallet 1. The plurality of anchor bores 124 receive a corresponding plurality of threaded clamp parts 5. The plurality of clamp parts 5, for each pallet 2, are configured into a first set of clamp parts 126 and a second set of claim parts 128. The first set of clamp parts 126 receive a sub pallet connector 9, which will be explained further below. The connector 9 may be referred to as a stud 9 or a zero point stud 9. The connector 9 is removably received in a sub pallet connector hole 129 in each of the threaded clamp parts 126. The sub pallet connector 9 may, thread, snap fit, or friction fit into the hole 129. The second set of clamp parts 128 receive a threaded bolt 7 and dowel 6. The threaded bolt 7 threads into the dowel 6.

The pallet 2 has an outer edge forming a pallet sidewall 130. A plurality of radially extending protrusions 132 extend radially from the pallet sidewall 130. A plurality of axially extending sleeves 134 corresponding to the radially extending protrusions 132 that extend axially from the radially extending protrusions 132. The plurality of radially extending protrusions 132 and the plurality of axially extending sleeves 134 correspond to the first set of clamp parts 126. The plurality of axially extending sleeves 134 each have a base 136 and a top 138. The base 136 includes a sub pallet connector detent 140 configured to be removably connected to the sub pallet connector 9. The sub pallet connector 9 may thread, snap fit, or friction fit into the detent 140. In certain embodiments, the sub pallet connectors 9 may be fixed to the bases 136 of the sleeves 134.

The tops 138 of the plurality of sleeves 134 are opposite the bases 136. The tops 138 in certain embodiments may have a divot 142 that receives a cap 10, 11. The cap 10, 11 may be referred to as a stud 10, 11, a pull stud 10, 11, or a clearance stud 10,11. While not shown, a bore may extend in each of the sleeves 134 from the top 138 to the base 136, which bore is plugged by the connector 9 and the cap 10, 11.

The tops 138 of the plurality of sleeves 134 each have a radially inwardly extending holder 144. The radially inwardly extending holder 144 comprises a pair of opposed arms 146 forming a channel 148 having a floor 150. The floor 150 has a threaded bore 151. The holders 144 are shaped and configured to receive hooks 152. The hook 152 has a countersunk bore 154 at a radially outward end 156 and an axially extending lip 158 at a radially inward end 160, which is opposite the outward end 156. The countersunk bore 154 is aligned over the threaded bore 152 such that a lock screw 162 can be threaded into the threaded bore 152 where the head 164 of the lock screw 8 abuts the countersunk bore 154 to lock the hook 152 in place. The holder 144 is configured to extend over an edge portion 166 about the showerhead 102 such that the hook 152 holds the showerhead 102 in place. The edge portion 166 about the perimeter of the showerhead 102 may be integral with the showerhead 102 or may be a shield part 168 wrapped about the outer axially extending surface of the showerhead 102.

The universal mount 100 also includes a robot interface 12 attached to the pallet 2, although it could be attached to the sub pallet 1. The robot interface, or robot end effector 12, is configured to attach to a robotic arm that is configured to attach to and allows the robotic arm, not shown, to move the universal mount 100. The movement may be movement in a particular process step machine, such as rotation orientation of the universal mount 100 in the machine, or between different process step machines. The interface 12 includes a plurality of anchor bores 124 and a plurality of threaded clamp parts 5 threaded into the anchor bores 124. The bores 129 in the threaded clamp parts 5 receive connectors 9. The pallet 2, in this exemplary embodiment, has a plurality of radially outwardly extending tangs 170 that have couple ports 172 (not visible) to receive ends of the connectors 9 wherein the interface 12 is removably coupled to the pallet 2.

Optionally, the pallet 2 or sub-pallet 1 may include a tongue 174 that is aligned with a groove 176 on the interface 12 to form a tongue and groove alignment for the interface 12 such that the sub pallet 1, pallet 2, and interface 12 have a defined orientation for the robotic control system, which facilitates precise movement of the universal mount 100.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. An mount configured to couple a plurality of showerheads to a robotic arm, the mount comprising;
a sub pallet comprising an outer portion extending radially inwardly from an outer edge of the sub pallet and a plurality of anchor bores in the outer portion of the sub pallet, the sub pallet has an outer diameter;
a plurality of clamp parts residing in the plurality of anchor bores, the plurality of clamp parts comprising at least a first set of clamp parts;
a pallet, the pallet having a pallet outer diameter less than the sub pallet outer diameter, the pallet comprising a pallet sidewall, a plurality of protrusions that extend radially outwardly from the pallet sidewall, and a plurality of axially extending sleeves extending from the plurality of protrusions, the plurality of axially extending sleeves having a bottom releasably coupled to the first set of clamp parts, the plurality of axially extending sleeves having a top opposite the bottom;
a plurality of radially inwardly extending holders coupled to the top of the plurality of axially extending sleeves;
a plurality of hooks wherein each hook comprises a radially outward portion coupled to a corresponding one of the plurality of radially inwardly extending holders and a radially inward portion comprising a lip that is configured to engage and hold an edge portion about at least one showerhead of the plurality of showerheads; and
a robot interface coupled to at least one of the sub pallet or pallet configured such that a robotic arm can manipulate the mount such that a precise location of the showhead is known.

2. The mount of claim 1 wherein the pallet comprises a plurality of pallets releasably coupled to the sub pallet.

3. The mount of claim 2 comprising a plurality of sub pallet connectors, where the bottom of each of the plurality of sleeves comprises one of the plurality of sub pallet connectors that are releasably coupled to the first set of the plurality of threaded clamp parts.

4. The mount of claim 1, wherein the plurality of holders each comprise a floor with a bore and the plurality of hooks each comprise a bore in the radially outward portion that aligns with the bore in the floor to receive a lock screw to releasably couple each of the plurality of hooks and the plurality of holders.

5. The mount of claim 1 wherein the plurality of clamp parts comprises a second set of clamp parts.

6. The mount of claim 5 wherein the first set of clamp parts and the second set of clamp parts equals the plurality of anchor bore.

7. The mount of claim 1 wherein the robot interface is coupled to the pallet.

8. The mount of claim 7 wherein the pallet comprises a pair of radially outwardly extending tangs to which the robot interface is coupled.

9. The mount of claim 8 wherein the sub pallet comprises a radially outwardly extending tongue that mates with a radially outwardly extending groove on an inner surface of the robot interface to form an alignment tongue and groove.

10. A system configured to couple a plurality of showerheads to a robotic arm, the system comprising;
a base having an outer edge defining an outer diameter and comprising an outer portion extending radially inwardly from the outer edge of the base the base;
a plurality of clamp parts in the outer edge of the base, wherein the plurality of clamp parts comprises a first set of clamp parts;
the system comprising a plurality of showerhead mounts, each of the plurality of showerhead mounts having a showerhead mount outer diameter that is less than the base outer diameter, the showerhead mount comprising a sidewall with a plurality of axially extending sleeves extending along the sidewall where each of the plurality of axially extending sleeves has a bottom releasably coupled to a corresponding clamp part of the first set of clamp parts, each of the plurality of axially extending sleeves having a top opposite the bottom wherein the top comprises a hook that is configured to engage an edge portion of a showerhead such that each of the plurality of showerhead mounts is configured to engage at least one of a plurality of showerheads; and
a robot interface coupled to at least one of the base or the showerhead mount.

11. The system of claim 10 wherein the robot interface is coupled to the showerhead mount.

12. The system of claim 10 wherein the outer portion of the base forms a bore and each of the plurality of showerhead mounts has a bore wherein the bores are to allow both side of the showerhead to be exposed.

13. The system of claim 10 comprising a plurality of connectors in the first set of clamp parts releasably coupled with the bottom of the bottoms of the plurality of axially extending sleeves.

14. The system of claim 10 comprising a shield part configured to be secured about the showerhead and to which the hook engages.

15. The system of claim 10 comprising a plurality of bolts extending through the plurality of axially extending sleeves.

16. The system of claim 10 wherein each of the plurality of axially extending sleeves has a divot at the top to receive a cap.

17. The system of claim 10 wherein each of the hooks is coupled to each of the tops by a lock screw.

18. A method to mount a plurality of showerheads for automatic processing, comprising:
providing a pallet, the pallet having an outer edge and an outer portion wherein the outer portion extends radially inwardly from the outer edge, the outer portion comprising at least a plurality of first clamp parts;
selecting a sub pallet from a plurality of sub pallets, wherein each sub pallet of the plurality of sub pallets is configured to engage at least one showerhead, wherein each of the sub pallets of the plurality of sub pallets comprises a plurality of axially extending sleeves;
engaging the showerhead to the selected sub pallet; and
coupling the selected sub pallet to the provided pallet, wherein a robotic arm is configured to engage with at least one of the pallet or the sub pallet such that the showerhead may be processed.

19. The method of claim 18, wherein the robotic arm engages the pallet.

20. The method of claim 18, wherein the robotic arm engages the sub pallet.
